(19) United States
(12) Patent Application Publication
(10) Pub. No.: US 2010/0115078 A1
(43) Pub. Date: May 6, 2010

(54) DISTRIBUTED STORAGE SYSTEM

(76) Inventors: Yasuo Ishikawa, Tokyo (JP); Kizuki Fukuda, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/531,625

(22) PCT Filed: Jul. 21, 2007
(86) PCT No.: PCT/JP2007/062508

§ 371 Date: Sep. 16, 2009

(30) Foreign Application Priority Data
Mar. 30, 2007 (JP) 2007-092342

(51) Int. Cl. G06F 15/173; G06F 15/16

(52) U.S. Cl. 709/223; 709/230; 709/245

(57) ABSTRACT

Provided is a distributed storage system capable of improving reliability and continuous operability while minimizing increases in management workload. A distributed storage system (100) includes storage devices (31 to 39) that store data and interface processors (21 to 25) that control the storage devices (31 to 39) in accordance with requests from a user terminal (10). Each of the storage devices (31 to 39) and the interface processors (21 to 25) store therein a node list containing an IP address of at least one of the storage devices (31 to 39). The interface processors (21 to 29) control the storage devices (31 to 39) based on the node lists. Each of the storage devices (31 to 39) make a request for the node list to a different interface processor every time. The interface processor that has received the request adds, to its own node list, the IP address of the storage device that has made the request.

### TECHNICAL FIELD

The present invention relates to a distributed storage system.

### BACKGROUND ART

As a storage system for managing data on a network, there has been conventionally known a network file system of a collective management type. FIG. 10 is a schematic diagram of a conventionally used network file system of the collective management type. The network file system of the collective management type is such a system in which a file server 201 that stores data is provided separately from a plurality of user terminals (clients) 202 and each of the user terminals 202 uses a file within the file server 201. The file server 201 holds management functions and management information. The file server 201 and the user terminals 202 are connected to each other via a communication network 203.

Such a configuration has a problem in that, if a fault occurs in the file server 201, none of the resources can be accessed until recovery, and therefore the configuration is highly vulnerable to a fault, showing low reliability as a system.

As a system for avoiding such a problem, there is known a distributed storage system. An example of the distributed storage system is disclosed in Patent Document 1. FIG. 11 illustrates a configuration example thereof. A network file system of a distributed management type includes a network 302 and a plurality of user terminals (clients) 301 connected thereto.

Each of the user terminals 301 is provided with a file sharing area 301a within its own storage, and includes therein a master file managed by the user terminal 301 itself, a cache file that is a copy of a master file managed by another user terminal 301, and a management information table containing management information necessary for keeping track of information of files scattered over the communication network 302. The user terminals 301 each establish a reference relationship with at least one of the other user terminals 301, and, exchange and correct the management information based on the reference relationship. All of the user terminals 301 on the network perform these operations in the same manner, and the information is sequentially propagated, which converges with a lapse of time, enabling all of the user terminals 301 to hold the same management information. When a user actually accesses a file, the user terminal 301 of the user acquires the management information from the management information table held therein, and then selects a user terminal 301 (cache client) having the file to be accessed. Next, the user terminal 301 of the user obtains file information from the user terminal 301 that is a master client and from the cache client, and makes a comparison therebetween. If there is a match, the file is obtained from the selected user terminal. If there is no match, the file is obtained from the master client. Further, in the case where there is no match, the cache client is notified that there is no match. The cache client that has received the notification deletes the file, obtains the file from the master client, and performs such processing as changing the management information table.

Patent Document 1: JP 2002-324004 A

### DISCLOSURE OF THE INVENTION

### Problems to be Solved by the Invention

However, in conventional distributed storage systems, management has become complicated in exchange for improvement in reliability, causing various problems.

For example, in a configuration as shown in Patent Document 1, a plurality of copies of a file need to be stored in order to improve reliability, and hence a large number of user terminals 301 are necessary when a large-capacity storage is constructed. Thus, as the number of user terminals 301 becomes larger, it takes a longer period of time for the management information to converge. In addition, due to the exchange of the management information and actual files among the user terminals 301, the hardware resources of the user terminals 301 are consumed and network load increases.

The present invention has been made to solve the above-mentioned problems, and therefore it is an object of the present invention to provide a distributed storage system capable of improving the reliability and the continuous operability while minimizing an increase in management workload.

### Means for Solving the Problems

In order to solve the above-mentioned problems, according to the present invention, there is provided a distributed storage system comprising: a plurality of storage devices that store data; and a plurality of interface processors that control the storage devices, wherein: the interface processors and the storage devices are capable of communicating with each other via a communication network according to an IP protocol; each of the interface processors stores a node list containing an IP address in the network of at least one of the storage devices; each of the storage devices makes a request for the node list to different interface processors; the interface processor to which the request has been made transmits the node list to the storage device which have made the request; and the interface processor to which the request has been made adds to the node list, the IP address of the storage device which has made the request.

The distributed storage system may further comprise a DNS server connected to the communication network, wherein: the DNS server stores a predetermined host name and the IP addresses of the plurality of interface processors in association with the predetermined host name; the DNS server makes, in response to an inquiry about the predetermined host name, a cyclic notification of one of the IP addresses of the plurality of interface processors; the storage devices make the inquiry about the predetermined host name to the DNS server; and the storage devices make the request for the node list based on the notified IP addresses of the interface processor.

Each of the interface processors may store at least one of the IP addresses of the storage devices contained in the node list, in association with information indicating a time point; and each of the interface processors may delete from the node list, in accordance with a predetermined condition, the IP address of a storage device associated with information indicating an oldest time point.

Each of the storage devices may store the node list containing an IP address of at least one of other storage devices; and each of the interface processors and each of the storage devices may transmit, to at least one of the storage devices contained in the node lists thereof, information regarding control of the at least one of the storage devices.

With regard to one of the storage devices and another one of the storage devices included in the node list of the one of the storage devices: the one of the storage devices may delete, from the node list thereof, the another one of the storage devices; the another one of the storage devices may add, to the node list thereof, the one of the storage devices; and the one of the storage devices and the another one of the storage devices may exchange all storage devices contained in the node lists thereof, excluding the one of the storage devices and the another one of the storage devices.

Each of the storage devices may update their own node lists based on the node list transmitted from the interface processors.

If each of the interface processors receives a request to write data from the outside, each of the interface processors may perform transmission/reception of information regarding a write permission of the data to/from another one of the interface processors; and each of the interface processors, which have received the request to write, may give an instruction to store the data, or give no instruction, to the storage devices, in accordance with a result of the transmission/reception of the information regarding the write permission.

### Effect of the Invention

According to the distributed storage system related to the present invention, the IP address of each storage device is contained in node lists of a plurality of interface processors. Therefore, even in a state in which some of the interface processors are not operating, writing and reading of a file can be performed by using the remaining interface processors. Thus, it is possible to improve reliability and continuous operability while minimizing an increase in management workload.

### BRIEF DESCRIPTION OF THE DRAWINGS

FIG. 1 is a diagram illustrating a construction including a distributed storage system according to the present invention.

FIG. 2 is a graph for describing a logical connection state of interface processors and storage devices of FIG. 1.

FIG. 3 shows Examples of node lists representing the graph of FIG. 2.

FIG. 4 shows diagrams illustrating steps in which the interface processor performs erasure correction encoding on data.

FIG. 5 is a flow chart illustrating a process flow performed when the storage devices and the interface processors update respective node lists.

FIG. 6 shows diagrams illustrating update processing performed in Steps S103a and S103b of FIG. 5.

FIG. 7 is a flow chart illustrating a process flow including an operation performed when the distributed storage system of FIG. 1 receives a file from a user terminal and stores the file therein.

FIG. 8 is a flow chart illustrating a process flow including an operation performed when the distributed storage system of FIG. 1 receives a file read request from the user terminal and transmits a file.

FIG. 9 is a flow chart illustrating an exclusive control process flow performed when the distributed storage system of FIG. 1 receives a file from the user terminal and stores the file therein.

FIG. 10 is a schematic diagram of a conventional network file system of a collective management type.

FIG. 11 is a schematic diagram of a conventional network file system of a distributed management type.

### BEST MODES FOR CARRYING OUT THE INVENTION

Hereinbelow, description is made of embodiments of the present invention with reference to the attached drawings.

### First Embodiment

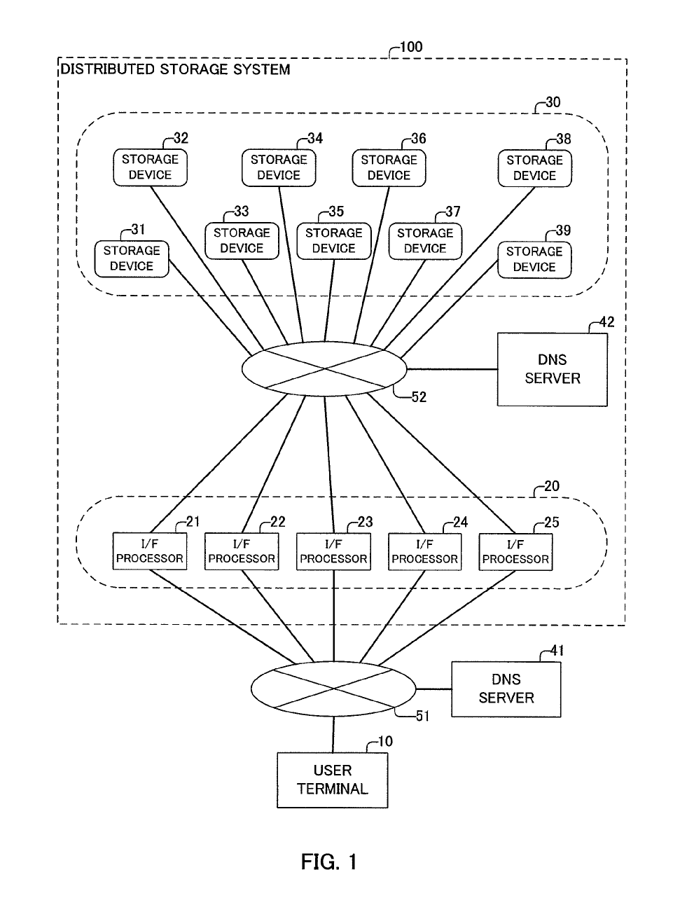

FIG. 1 illustrates a construction including a distributed storage system 100 according to the present invention. The distributed storage system 100 is communicably connected to a user terminal 10, which is a computer used by a user of the distributed storage system 100, via the Internet 51, which is a public communication network.

The distributed storage system 100 includes a storage device group 30 for storing data and an interface processor group 20 for controlling the storage device group 30 in accordance with a request from the user terminal 10. The interface processor group 20 and the storage device group 30 are communicably connected via a local area network (LAN) 52, which is a communication network.

The interface processor group 20 includes a plurality of interface processors. In this embodiment five interface processors 21 to 25 are illustrated, but the number thereof may be different.

The storage device group 30 includes a plurality of storage devices. The number of storage devices is, for example, 1000, but only nine storage devices 31 to 39 are used for description in this embodiment for the sake of simplification.

The user terminal 10, the interface processors 21 to 25, and the storage devices 31 to 39 each have a construction as a well-known computer and comprise input means for receiving external input, output means for performing external output, operation means for performing operation, and storage means for storing information. The input means includes a keyboard and a mouse; the output means, a display and a printer; the operation means, a central processing unit (CPU); the storage means, a memory and a hard disk drive (HDD). Further, those computers execute programs stored in the respective storage means, thereby realizing the functions described herein.

The user terminal 10 includes a network card that is input/output means directed to the Internet 51. The storage devices 31 to 39 each include a network card that is input/output means directed to the LAN 52. The interface processors 21 to 25 each include two network cards. One of the network cards is input/output means directed to the Internet 51 and the other is input/output means directed to the LAN 52.

The user terminal 10, the interface processors 21 to 25, and the storage devices 31 to 39 are each assigned with an IP address associated with the network card thereof.

To give an example, for the LAN 52, the IP addresses of the interface processors 21 to 25 and the storage devices 31 to 39 are specified as follows:

Interface processor 21—192.168.10.21;

Interface processor 22—192.168.10.22;

Interface processor 23—192.168.10.23;

Interface processor 24—192.168.10.24;

Interface processor 25—192.168.10.25;

Storage device 31—192.168.10.31;

Storage device 32—192.168.10.32;

Storage device 33—192.168.10.33;

Storage device 34—192.168.10.34;

Storage device 35—192.168.10.35;

Storage device 36—192.168.10.36;

Storage device 37—192.168.10.37;

Storage device 38—192.168.10.38; and

Storage device 39—192.168.10.39.

Similarly, for the Internet 51, the IP addresses of the user terminal 10 and the interface processors 21 to 25 are specified. A specific example thereof is omitted, but it is only necessary that the IP addresses be different from one another.

A DNS server 41, that is a DNS server having a well-known construction, is communicably connected to the Internet 51. The DNS server 41 stores a single host name and the IP address of each of the interface processors 21 to 25 for the Internet 51 in association with the single host name, and operates according to a so-called round-robin DNS method. Specifically, in response to an inquiry made by the user terminal 10 about the single host name, the DNS server 41 sequentially and cyclically notifies the user terminal 10 of the five IP addresses, which respectively correspond to the interface processors 21 to 25.

Similarly, a DNS server 42, that is a DNS server having a well-known configuration, is communicably connected to the LAN 52. The DNS server 42 stores a single host name and the IP address of each of the interface processors 21 to 25 for the LAN 52 in association with the single host name. In response to an inquiry made by the storage devices 31 to 39 about the single host name, the DNS server 42 sequentially notifies the storage devices 31 to 39 of the IP addresses of the interface processors 21 to 25 according to the round-robin DNS method.

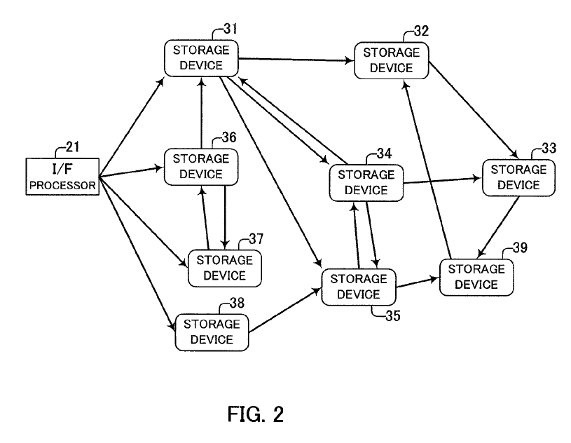

FIG. 2 is a graph for describing a logical connection state of the interface processors 21 to 25 and the storage devices 31 to 39 of FIG. 1. This logical connection state is shown as a digraph consisting of nodes, which represent the interface processors 21 to 25 and the storage devices 31 to 39, and lines having respective direction and connecting the nodes. It should be noted that, for the sake of simplification, FIG. 2 illustrates only the interface processor 21 as the interface processor, but, in actuality, the other interface processors 22 to 25 are also included in the graph.

The graph includes lines having directions from the interface processor 21 (the same applies to the interface processors 22 to 25) to at least one of the storage devices 31 to 39, e.g. to the storage devices 31, 36, 37, and 38. On the other hand, the graph does not include any lines having directions from the storage devices 31 to 39 to the interface processor 21 (the same applies to the interface processors 22 to 25). Further, among the storage devices, there may be no line, there may be a unidirectional line, or there may be a bidirectional line.

It should be noted that the graph is not fixed and varies according to operation of the distributed storage system 100. Description thereof is given later.

In the distributed storage system 100, the logical connection state is shown as a set of node lists. A node list is created for every node.

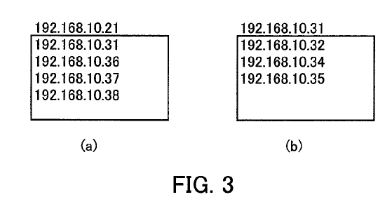

FIG. 3 shows examples of the node lists representing the graph of FIG. 2. If the graph has a line having a direction from one node to another node, the node list of the node serving as the starting point of the line contains information representing the node serving as the endpoint of the line, e.g. an IP address for the LAN 52.

FIG. 3(a) illustrates a node list created for the interface processor 21 (having the IP address 192.168.10.21) illustrated in FIG. 2. This node list is stored in the storage means of the interface processor 21. The node list contains the IP addresses representing the storage devices 31, 36, 37, and 38.

Similarly, FIG. 3(b) illustrates anode list created for the storage device 31 (having the IP address 192.168.10.31) illustrated in FIG. 2. This node list is stored in the storage means of the storage device 31. The node list contains the IP addresses representing the storage devices 32, 34, and 35.

The interface processors 21 to 25 each have a function of performing erasure correction encoding on data by means of a well-known method.

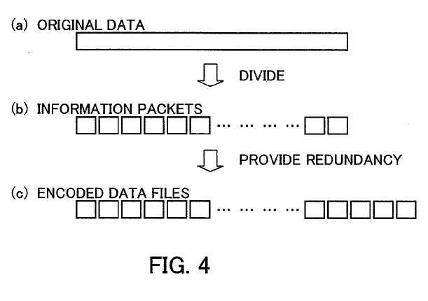

FIG. 4 illustrate steps in which the interface processor 21 (the same applies to the interface processors 22 to 25) performs the erasure correction encoding on data. FIG. 4(a) represents original data, and illustrates a state in which information is provided as one whole chunk. The interface processor 21 divides the original data to create a plurality of information packets. FIG. 4(h) illustrates a state in which, for example, 100 information packets are created. Further, the interface processor 21 provides redundancy to the information packets, thereby creating encoded data files that are larger in number than the information packets. FIG. 4(c) illustrates a state in which, for example, 150 encoded data files are created.

The 150 encoded data files are so constructed that the original data can be reconstructed by collecting, for example, any 105 encoded data files out of the 150 encoded data files. The above-mentioned encoding and decoding methods are based on well-known techniques such as erasure correcting codes or error correcting codes. The number of the encoded data files or a minimum number of the encoded data files necessary for the reconstruction of the original data may be changed as appropriate.

The interface processor 21 stores programs for performing the above-mentioned encoding and decoding within the storage means thereof, and functions as encoding means and decoding means by executing the programs.

The distributed storage system 100 has a function of dynamically updating the logical connection state exemplified in FIG. 2.

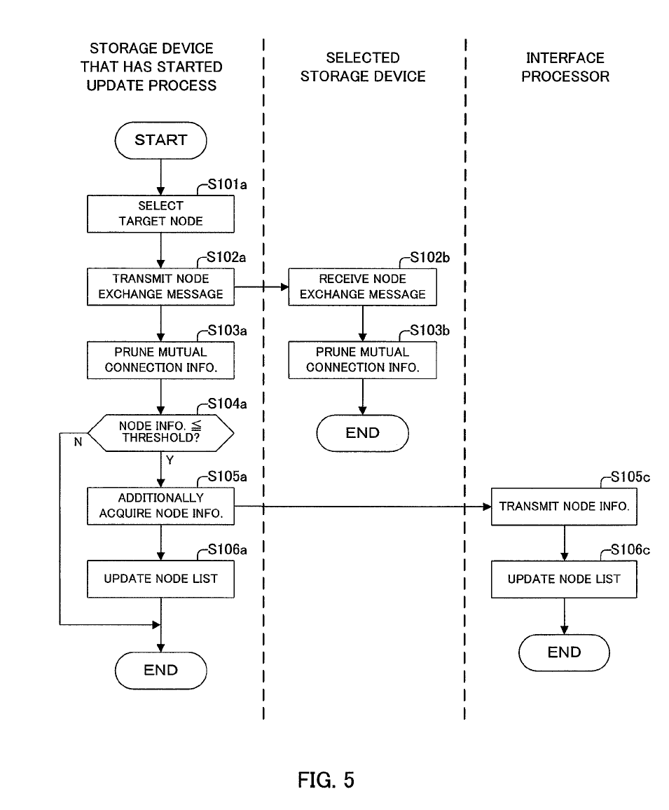

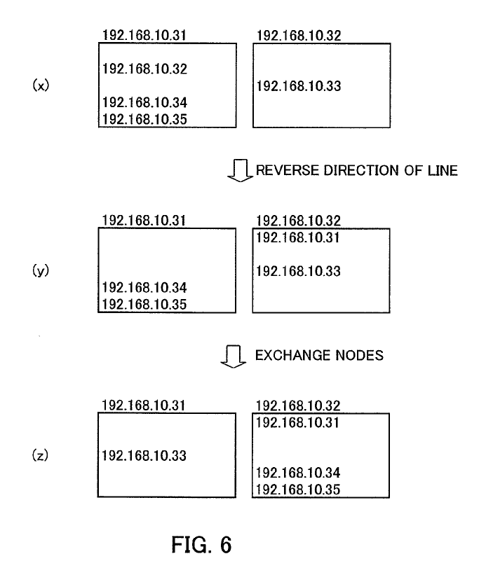

FIGS. 5 and 6 are diagrams illustrating a process flow performed when the storage devices 31 to 39 and the interface processors 21 to 25 update the respective node lists.

Each of the storage devices (hereinbelow, as an example, storage device 31) starts executing the process of the flow chart of FIG. 5 at given timings, for example, every two minutes. The storage device that has started the execution is a storage device that has started an update process.

First, the storage device 31 selects one of the nodes contained in its own node list as a target of the update processing (Step S101a). Here, a node that has never been selected so far or a node that has not selected for the longest period of time is selected. In a case where there are a plurality of nodes that satisfy the condition, one node is selected randomly from among those nodes. Though not illustrated in the figure, the IP address of the selected node is stored in association with a time stamp indicating that time point, which is referred to as a selection reference in the next execution of the process. It should be noted that, as an alternative, the IP address and the time stamp need not be associated with each other. In this case, if a node is to be selected in Step S101a, one node is selected randomly from among the nodes contained in the node list.

Hereinafter, as one example, it is assumed that the storage device 32 is selected.

Next, the storage device 31 transmits, to the selected node, a node exchange message indicating that the node has been selected as a target of the update process (Step S102a). The storage device 32 receives the node exchange message (Step S102b), and recognizes that the storage device 32 has been selected as the target of the update process to be performed by the storage device 31.

Next, the storage devices 31 and 32 execute pruning on mutual connection information, thereby updating their node lists (Steps S103a and S103b).

FIG. 6 shows diagrams illustrating the update processing performed in Steps S103a and S103b. FIG. 6 (x) illustrates the node lists of the storage devices 31 and 32 before those steps are started. This corresponds to the connection state of FIG. 2. The node list of the storage device 31 contains the storage devices 32, 34, and 35, whereas the node list of the storage device 32 contains only the storage device 33.

In Steps S103a and S103b, the storage devices 31 and 32 first reverse the direction of a line having a direction from the storage device 31 that has started the update process to the storage device 32 that has been selected as the target of the update process. Specifically, the storage device 32 is deleted from the node list of the storage device 31, and the storage device 31 is added to the node list of the storage device 32 (if the storage device 31 is already contained therein, there is no need to change). At this point, the node lists indicate such contents as illustrated in FIG. 6 (y).

Further, the storage devices 31 and 32 exchange the other nodes in their node lists. The storage devices 34 and 35 are deleted from the node list of the storage device 31, and then added to the node list of the storage device 32. In addition, the storage device 33 is deleted from the node list of the storage device 32, and then added to the node list of the storage device 31. At this point, the node lists indicate such contents as illustrated in FIG. 6 (z).

Here, in the pruning of the mutual connection information performed in Steps S103a and S103b, the total number of nodes contained in the node lists of all the storage devices, that is, the total number of lines between the storage devices illustrated in the graph of FIG. 2 may not change or may decrease, but does not increase. This is because a line having a direction from a storage device that has started the update process to a storage device selected as the target of the update process is always deleted, but a line having the opposite direction thereto may be added or may not be added (that is, the case in which such a line is already present).

In this manner, the storage devices 31 and 32 execute the pruning of the mutual connection information in Steps S103a and S103b. After that, the selected storage device 32 ends the processing.

Next, the storage device 31 determines whether or not the number of nodes contained in its node list is equal to or smaller than a given number, for example, four (Step S104a of FIG. 5). If the number of nodes is larger than the given number, the storage device 31 ends the processing.

If the number of nodes is equal to or smaller than the given number, the storage device 31 requests one of the interface processors 21 to 25 to transmit node information (i.e. a node list), and, after acquiring the node list, adds nodes contained in this node list to its own node list (Step S105a). The interface processor that was selected as the target of the request, in response to the request, transmits its own node list to the storage device 31 (Step S105c). As illustrated in FIG. 3(a), the node list contains at least one of the IP addresses of the storage devices 31 to 39.

Here, the storage device 31 makes an inquiry to the DNS server 42 using a predetermined host name, and acquires the node information from the interface processor having the acquired IP address. The DNS server 42 performs notification according to the round-robin method as described above, and hence the storage device 31 acquires the node information from a different interface processor every time Step S105a is executed. Hereinafter, it is assumed, for example, that the DNS server 42 notifies the storage device 31 of the IP address of the interface processor 21.

Next, the storage device 31 and the interface processor 21 update the respective node lists in accordance with results of Steps S105a and S105c (Steps S106a and S106b).

Here, the storage device 31 adds, to its own node list, the nodes that are included in the acquired nodes and are not contained in its own node list, excluding the storage device 31 itself.

Further, the interface processor 21 adds the storage device 31, which is a node of a request source, to its own node list. Here, the interface processor 21 stores the added node in association with information indicating a time point at which that node is added, e.g. a time stamp. Then, if a predetermined condition is satisfied, for example, if the number of nodes in the node list has become equal to or larger than a given number, the interface processor deletes the node associated with the oldest time stamp from the node list. It should be noted that, as an alternative, the interface processor 21 may also not associate the node with the time stamp. In this case, in selecting a node to be deleted from the node list, one node is selected randomly from among the nodes contained in the node list. Further, the interface processor 21 may store the node list as a list having a particular order. Specifically, the node list may be constructed in such a manner that the order the nodes were added to the node list can be determined. In this case, the selection of a node to be deleted from the node list may also be carried out from the oldest node according to the order of addition to the node list, that is, in a first-in first-out (FIFO) method.

In this manner, the distributed storage system 100 dynamically updates the logical connection state among the nodes.

Further, if a storage device that is not included in FIG. 1 is newly added to the distributed storage system 100, the new storage device first acquires a node list from one of the interface processors, and holds this node list as an initial node list. That is, in this case, the added storage device has an empty node list, and hence Steps S101a, S102a, S102b, S103a, and S103b are not executed. Further, in Step S104a, the node information contains zero items, which is obviously equal to or smaller than the predetermined number, and hence Steps S105a and S105c and Steps S106a and S106c of FIG. 5 are executed.

In this manner, by repeatedly executing the update of the node lists described by way of FIGS. 5 and 6 at the respective storage devices at predetermined timings, a newly-added storage device which does not have any line at first comes to have a unidirectional line or bidirectional lines, whereby a digraph having various patterns is built.

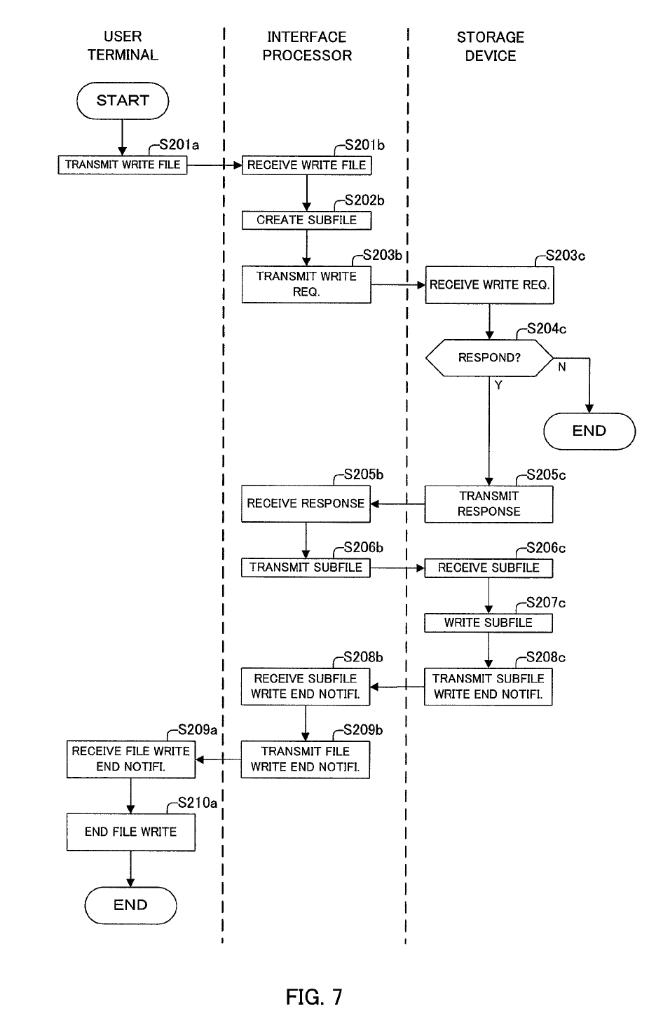

FIG. 7 is a flow chart illustrating a process flow including an operation performed when the distributed storage system 100 receives a file from the user terminal 10 and stores the file therein.

First, in accordance with an instruction given by a user, the user terminal 10 transmits, to the distributed storage system 100, a write file to be stored in the distributed storage system 100 (Step S201a).

Here, the user terminal 10 makes an inquiry to the DNS server 41 using a predetermined host name, and then transmits the write file to the interface processor having the acquired IP address. The DNS server 41 performs the notification according to the round-robin method as described above, and hence the user terminal 10 transmits a write file to a different interface processor every time. Hereinafter, as one example, it is assumed that the write file is transmitted to the interface processor 21.

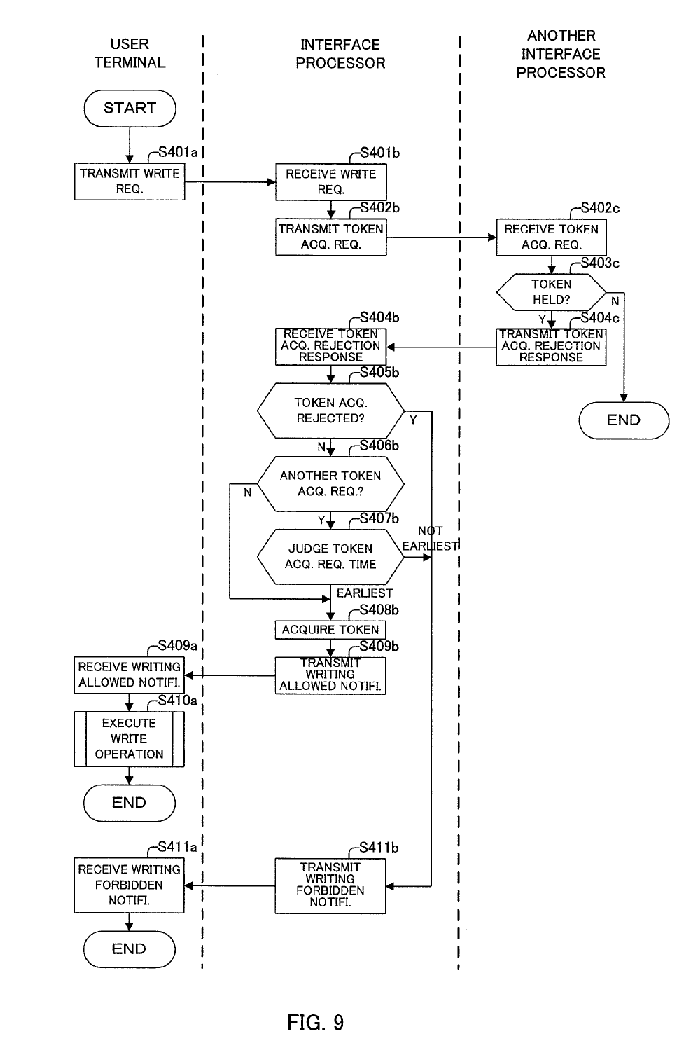

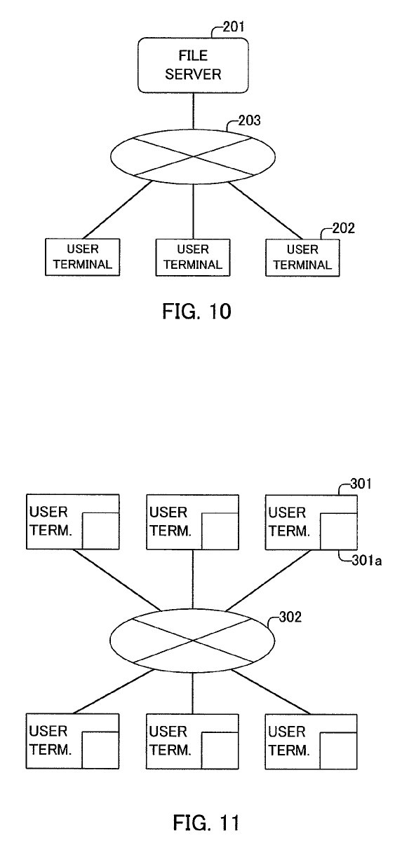

Here, in a case where an interface processor that is to perform a write process of the file is already determined and the IP address thereof is stored in the user terminal 10, the user terminal 10 does not make an inquiry to the DNS server 41, and performs transmission by directly using the IP address. For example, the following state corresponds to such a case: as a result of exclusive control process (described later with reference to FIG. 9), a particular interface processor is in possession of a token that permits writing of the file.

Upon reception of the write file (Step S201b), the interface processor 21 divides the write file and performs the erasure correction encoding thereon, thereby creating a plurality of subfiles (Step S202b). This is performed using the method described with reference to FIG. 4.

Next, the interface processor 21 transmits a request to write (a write request) to the storage devices 31 to 39 (Step S203b), and the storage devices 31 to 39 receive the write request (Step S203c). In accordance with the graph illustrated in FIG. 2, the write request is transmitted from the interface processor 21 to the storage devices specified in the node list thereof, and is further transmitted to the node lists specified in the node lists of those respective storage devices. This is repeated to transfer the write request between the storage devices.

The write request contains the following data:

the IP address of the interface processor that has transmitted the write request;

a message ID for uniquely identifying the write request;

a hop count representing the number of times the write request has been transferred; and

a response probability representing the probability of each storage device having to respond to the write request.

Here, an initial value of the hop count is, for example, 1. Further, based on the total number of storage devices and the number of subfiles, the interface processor 21 determines the response probability so that the probability that the number of storage devices to respond will be equal to or larger than the number of subfiles is sufficiently high. For example, assuming that the number of storage devices (specified in advance, and stored in the storage means of the interface processor 21) is 1,000 and the number of subfiles is 150, the response probability may be set as 150/1,000=0.15 in order to obtain an expected value of the number of responding storage devices equal to the number of subfiles. However, if the probability that the number of responding storage devices is equal to or larger than the number of subfiles is to be made sufficiently high, the response probability may be set as 0.15×1.2=0.18, giving a 20% margin, for example.

It should be noted that, as an alternative, the write request may also contain no hop count.

As a specific example, the following algorithm is used for the transmission/reception of the write request.

(1) A transmitting node, e.g. the interface processor 21, transmits a write request to all the nodes contained in its own node list.

(2) A receiving node, e.g. the storage device 31, refers to the message ID of the received write request, and determines whether or not the write request is already-known, that is, whether or not the write request has been already received.

(3) If the write request is already-known, the receiving node ends the processing.

(4) If the write request is not already-known, the receiving node transmits the write request as a transmission node in a manner similar to the case of the above item (1). Upon this, the hop count of the write request is incremented by one.

In this manner, all of the storage devices 31 to 39 connected by the digraph receive the write request.

Next, each of the storage devices 31 to 39 determines whether or not to respond to the received write request (Step S204c). The determination is made randomly in accordance with the response probability. For example, if the response probability is 0.18, each of the storage devices 31 to 39 determines to respond with the probability of 0.18 and determines not to respond with a probability of 1−0.18=0.82.

If it is determined not to respond, the storage device ends the processing.

If it is determined to respond, the storage device transmits a response toward the IP address of the interface processor contained in the write request (in this case 192.168.10.21) (Step S205c). The response contains the IP address of the storage device.

The interface processor 21, which is a transmission source of the write request, receives the response (Step S205b), and then transmits a subfile to the IP address contained in the response, that is, to the responding storage device (Step S206b). Here, one subfile is transmitted to one storage device.

If the number of responding storage devices is larger than the number of subfiles, the interface processor 21 selects storage devices in accordance with a predetermined standard. For example, the standard is set such that data is distributed as geographically as possible, that is, such that the maximum number of storage devices included in one location is reduced.

The storage device that has responded to the write request receives a subfile (Step S206c). Though not illustrated in FIG. 7, a storage device that has responded but has not received a subfile ends the processing.

The storage device that has received a subfile stores the subfile in its own storage means (Step S207c). This means that the subfile has been written to the distributed storage system 100.

After that, each storage device transmits a subfile write end notification to the interface processor 21 (Step S208c). The interface processor 21 receives this notification from all the storage devices to which the subfiles have been transmitted (Step S208b). This means that the entire amount of the original data has been written to the distributed storage system 100.

After that, the interface processor 21 transmits a file write end notification to the user terminal 10 (Step S209b), and the user terminal 10 receives this notification (Step S209a) to end the file write process (Step S210a).

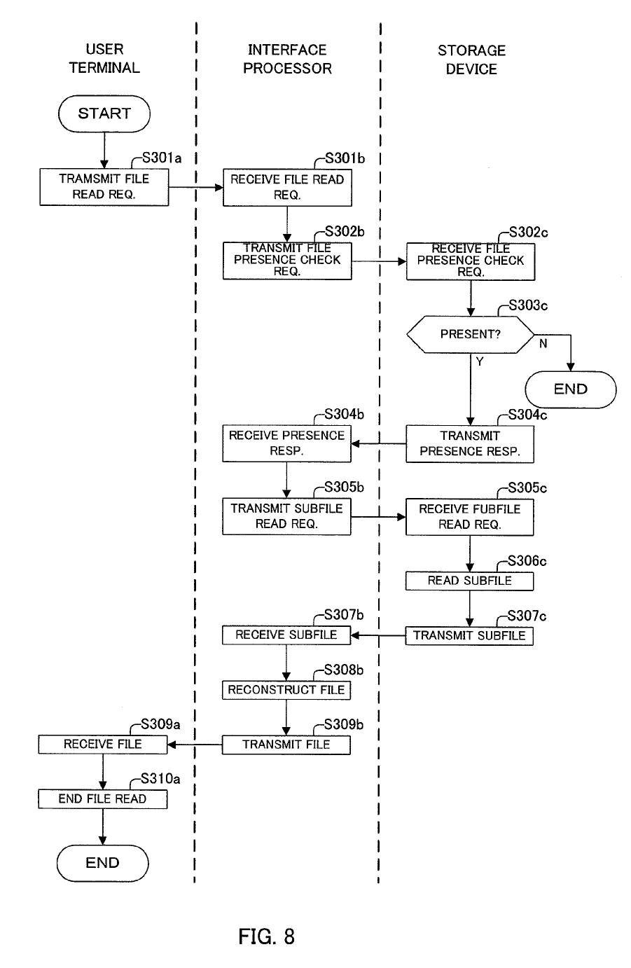

FIG. 8 is a flow chart illustrating a process flow including an operation performed when the distributed storage system 100 receives a file read request from the user terminal 10 and transmits a file.

First, the user terminal 10 receives an instruction to read a particular file from the user, and, in accordance with this instruction, transmits a file read request to the distributed storage system 100 (Step S301a).

Here, similarly to Step S201a of FIG. 7, a DNS inquiry is made by using the round-robin method. That is, the user terminal 10 transmits a file read request to a different interface processor every time. Hereinafter, as one example, it will be assumed that the file read request is transmitted to the interface processor 21.

The interface processor 21 receives the file read request (Step S301b), and then transmits a file presence check request to the storage devices 31 to 39 (Step S302b). The storage devices 31 to 39 receive this request (Step S302c). The file presence check request is transmitted/received using a method similar to that of the write request in Step S203b of FIG. 7. That is, in accordance with the graph illustrated in FIG. 2, the file presence check request is transmitted from the interface processor 21 to the storage devices specified in the node list thereof, and is further transmitted to the node lists specified in the node lists of those respective storage devices. This is repeated to transfer the file presence check request among the storage devices.

The file presence check request contains the following data:

information for identifying a file that is a target of the file read request, such as a file name;

the IP address of the interface processor that has transmitted the file presence check request;

a message ID for uniquely identifying the file presence check request; and

a hop count representing the number of times the file presence check request has been transferred.

Here, an initial value of the hop count is, for example, 1. Alternatively, the file presence check request may also contain no hop count.

Next, the storage devices 31 to 39 each determines whether or not a subfile of the file is stored therein (Step S303c).

If a subfile is not stored, the storage device ends the processing.

If a subfile is stored, the storage device transmits a presence response indicating the presence of the file to the IP address of the interface processor contained in the file presence check request (in this case 192.168.10.21) (Step S304c). The response contains the IP address of the storage device.

The interface processor 21, which is the transmission source of the file presence check request, receives the presence response (Step S304b), and transmits a subfile read request to the IP address contained in the presence response, i.e. to the responding storage device (Step S305b).

The storage device that has transmitted the presence response, receives the subfile read request (Step S305c), and then reads the subfile from its own storage means (Step S306c), and transmits the subfile to the interface processor 21 (Step S307c).

The interface processor 21 receives subfiles from at least a portion of the storage devices that have transmitted subfiles (Step S307b). Further, based on the received subfiles, the interface processor 21 performs erasure correction decoding thereon, thereby reconstructing the file being requested by the user terminal 10 (Step S308b). The decoding is performed using a well-known method corresponding to the encoding method described with reference to FIG. 4. Note that the original file can be reconstructed without obtaining all of the subfiles because the subfiles are redundant.

After that, the interface processor 21 transmits the decoded file to the user terminal 10 (Step S309b), and the user terminal 10 receives this file (Step S309a) to end the file read process (Step S310a).

FIG. 9 is a flow chart illustrating an exclusive control process flow performed when the distributed storage system 100 receives a file from the user terminal 10 and stores the file therein. The exclusive control process is performed so as to prevent simultaneous writing of the same file from a plurality of the interface processors.

Tokens are used in this control. Each token is associated with one file and indicates whether writing the file is permitted or prohibited. For each file, no more than one interface processor can store the token in the storage means, and hence only the interface processor storing the token can write the file (this includes saving a new file and updating an existing file).

First, in response to an instruction from the user, the user terminal 10 transmits a write request for writing a file to the distributed storage system 100 (Step S401a).

Here, similarly to Step S203a of FIG. 7, a DNS inquiry is made by using the round-robin method. Hereinafter, as one example, it will be assumed that the file write request is transmitted to the interface processor 21.

The interface processor 21 receives the write request (Step S401b), and then transmits a token acquisition request for the exclusive control to the other interface processors 22 to 25 (Step S402b). The token acquisition request contains the following data:

the IP address of the interface processor that has transmitted the token acquisition request;

information for identifying a file that is a target of the token acquisition request, such as a file name; and

a time stamp indicating a time point at which the token acquisition request is created.

Each of the other interface processors 22 to 25 receive the token acquisition request (Step S402c), and then determine whether or not the interface processor is holding the token for the file (Step S403c).

Regarding the other interface processors 22 to 25, if they determine that they are not holding the token for the file, they end the process.

If one determines that it is holding the token for the file, that interface processor transmits, to the interface processor 21 that has transmitted the token acquisition request, a token acquisition rejection response indicating that the token has already been acquired (Step S404c).

The interface processor 21 waits for the token acquisition rejection response, and receives the response if there is any response transmitted (Step S404b). Here, the interface processor 21 waits for a given period of time after the execution of Step S402b, e.g. 100 ms, during which time the token acquisition rejection response can be accepted.

Next, the interface processor 21 determines whether or not the token acquisition rejection response has been received in Step S404b (Step S405b). If it is determines that the token acquisition rejection response has been received, the interface processor 21 transmits an unwritable notification to the user terminal 10 (Step S411b), and the user terminal 10 receives the unwritable notification (Step S411a). In this case, the user terminal 10 does not execute the writing of the file, and carries out the unwritable notification of the user through a well-known method. In other words, the user terminal 10 does not execute Step S201a of FIG. 7.

If it is determined in Step S405b that the token acquisition rejection response has not been received, the interface processor 21 determines whether or not a token acquisition request has been received from the other interface processors 22 to 25 during a period from the start of execution of Step S401b to the completion of execution of Step S405b (Step S406b).

If a token acquisition request has not been received from the other interface processors 22 to 25, the interface processor 21 acquires a token corresponding to the file (Step S408b). Specifically, the interface processor 21 creates a token, and then stores the token in the storage means.

In a case where the token acquisition request has been received from any of the other interface processors 22 to 25, the interface processor 21 performs time point comparison among the token acquisition request it has transmitted and the other token acquisition requests that have been received from other interface processors (Step S407b). This comparison is performed by comparing the time stamps contained in the respective token acquisition requests.

In Step S407b, if its own token acquisition request is the earliest, i.e. if the time stamp is the oldest, the interface processor 21 advances to Step S408b and acquires the token as described above. Otherwise, the interface processor 21 advances to Step S411b and transmits the unwritable notification as described above.

After acquiring the token in Step S408b, the interface processor 21 transmits a writable notification to the user terminal 10 (Step S409b), and the user terminal 10 receives the writable notification (Step S409a). After that, the user terminal 10 executes the write operation (Step S410a). Specifically, the user terminal 10 executes Step S201a of FIG. 7, and thereafter, the flow chart of FIG. 7 is executed.

It should be noted that the token that has been acquired in Step S408b is released at the time of completion of Step S208b of FIG. 7 for example, and the interface processor 21 deletes the token from the storage means thereof.

Hereinbelow, description is made of an example of the flow of the process performed by the distributed storage system 100 operating as described above.

After the distributed storage system 100 is constructed and starts operating, the logical connection state illustrated in FIG. 2 is formed among the interface processors 21 to 25 and the storage devices 31 to 39. Regardless of whether or not there is an instruction from the user terminal 10, the connection state is automatically and dynamically updated at appropriate timings through the process illustrated in FIG. 5. Therefore, even if a fault occurs in any one of the nodes or a communication path between nodes, a path bypassing the fault is generated, thereby attaining a system having high fault tolerance.

Along with the repetition of the processing of FIG. 5 with the lapse of time, that is, the repetition of the pruning of the mutual connection information performed in Steps S103a and S103b, the number of nodes contained in the node list of each storage device gradually decreases. In other words, the graph of FIG. 2 becomes sparse due to a gradual decrease in the number of lines. Here, in Step S105a of FIG. 5, when the number of pieces of the node information contained in the node list of each storage device has become equal to or smaller than a threshold (for example, four), the node information is additionally acquired, whereby the number of pieces of the node information is increased. Through setting this threshold, it becomes possible to adjust an average shortest path length of the graph of FIG. 2, i.e. an average hop count in transmitting a message from the interface processors 21 to 25 to the storage devices 31 to 39. The average shortest path length is expressed as:

[{ln(N)−γ}/ln(<k>)]+1/2

where N represents the number of nodes; γ represents the Euler's constant (approximately 0.5772); <k> represents an average value of the number of pieces of the node information contained in the node lists; and In represents the natural logarithm.

It should be noted that, in a case where the average shortest path length can be obtained through measurement, the number of storage devices can be back-calculated by solving the above expression for N. In Step S203b of FIG. 7, the interface processor 21 stores the number of storage devices in advance in order to determine the response probability to be contained in the write request. However, as an alternative, the number of storage devices may be obtained through such back-calculation. In this case, upon transferring the write request in Step S203b of FIG. 7 and upon transferring the file presence check request in Step S302b of FIG. 8, each storage device notifies the interface processor 21 of the hop count, and the interface processor 21 averages the hop counts of all the storage devices to thereby obtain a measured value of the average shortest path length.

Further, when the storage devices 31 to 39 make a request for a node list as described above, the interface processor that has received the request transmits the node list, and also adds, to its own node list, the IP address of the storage device that has made the request for the transmission (Step S106c). Here, in response to an inquiry about an IP address of the interface processor, which is made by the storage devices 31 to 39, the DNS server 42 notifies the storage devices 31 to 39 of the IP address of a different interface processor every time, and hence the storage devices 31 to 39 make a request for a node list to a different interface processor every time. With this construction, the IP addresses of all storage devices 31 to 39 are contained in the node lists of a plurality of different interface processors.

Here, for example, it will be assumed that a user of the distributed storage system 100 instructs the distributed storage system 100 via the user terminal 10 to store a file having a file name “ABCD”. In response to this, the distributed storage system 100 executes the exclusive control process illustrated in FIG. 9, and the interface processor 21, for example, acquires a token for the file ABCD. There is employed such a mechanism in which each of the interface processors 21 to 25 independently perform a token acquiring operation and no separate system for managing tokens is provided, and hence the distributed storage system 100 can be built without any mechanism for collective management.

After the interface processor 21 acquires the token, the user terminal 10 and the distributed storage system 100 execute the write process illustrated in FIG. 7. Here, the interface processor 21 divides the file ABCD into 100 information packets, which are further provided with redundancy and made into 150 subfiles (Step S202b). Further, the interface processor 21 transmits, to all the storage devices, a write request in which the response probability is specified as 0.18 (Step S203b). The write request is transferred using a bucket brigade method in accordance with such a graph as illustrated in FIG. 2. Each storage device transmits a response with the specified probability of 0.18 (Step S205c). Upon this, the IP address of the interface processor 21 is contained in the write request, and hence there is no need for the storage devices to know the IP address of the interface processor 21 (and the IP addresses of the other interface processors 22 to 25) in advance.

The interface processor 21 performs the transmission of the subfiles based on the received responses, and the respective storage devices store the subfiles in the storage means (Step S207c).

Here, there is no need for the interface processors 21 to 25 to manage regarding which storage devices store the subfiles of the file ABCD, and hence the distributed storage system 100 can be built without any mechanism for collective management.

Further, even if some of the storage devices are not operating properly due to such factors as breakdowns, power interruptions or maintenance of individual storage devices, or due to breaks in the network lines, it is possible to acquire a necessary number of subfiles from the remaining operating storage devices by using the erasure correction encoding technique. Thus, the original file can be accurately generated through the decoding, which therefore makes it possible to attain high reliability and continuous operability.

Further, the user of the distributed storage system 100 instructs the distributed storage system 100 via the user terminal 10 at a desired time point to read the file ABCD stored in the distributed storage system 100. In response to this, the interface processor 21, for example, transmits the file presence check as illustrated in FIG. 8 (Step S302b), and receives the subfiles from the responding storage devices (Step S307b). Here, similarly to the case of the write process, the IP address of the interface processor 21 is contained in the file presence check request, and hence there is no need for the storage devices to know that IP address in advance. Further, the interface processor 21 does not need to manage regarding which storage devices store the subfiles of the file ABCD, and hence the distributed storage system 100 can be built without any mechanism for collective management.

The interface processor 21 reconstructs the file ABCD based on the received subfiles (Step S308b), and then transmits this file to the user terminal 10.

As described above, according to the distributed storage system 100 related to the present invention, each of the interface processors 21 to 25 and the storage devices 31 to 39 store a node list containing at least one of the IP addresses of the storage devices 31 to 39. The interface processors 21 to 29 control the storage devices 31 to 39 based on the node lists.

Here, the storage devices 31 to 39 make a request for a node list to a different interface processor every time, and hence the IP address of all of the storage devices 31 to 39 are to be contained in the node lists of a plurality of interface processors. Therefore, even in a state in which some of the interface processors 21 to 25 are not operating, the writing and the reading of a file can be performed by using the remaining interface processors, which improves reliability and continuous operability while minimizing an increase in management workload.

Further, the DNS round-robin method enables the load to be distributed over a plurality of the interface processors 21 to 25, and hence it is possible to avoid a situation in which the load on a particular interface processor or its surrounding network increases heavily.

Further, the interface processors 21 to 25 use the erasure correction encoding technique to create a plurality of subfiles, and a plurality of storage devices each store one subfile. Therefore, even if some of the storage devices 31 to 39 are not operating, the reading of a file can be performed by using the remaining storage devices, which further improves reliability and continuous operability.

Additionally, the storage devices 31 to 39 and a newly-added storage device make requests for the node lists of the interface processors 21 to 25, and, based on the node lists, automatically update or create their own node lists. Therefore, an operation of changing the settings, which would otherwise be required due to the addition of the new storage device, is unnecessary, thereby attaining reduction in workload for changing the configuration. In particular, a new storage device to be added only needs to store just the IP address of the DNS server 42 and a single host name shared among the interface processors 21 to 25, and there is no need to store different IP addresses of the respective interface processors 21 to 25.

Further, according to the distributed storage system 100 related to the present invention, compared with a conventional distributed storage system, the following effects can be obtained.

The subfiles are stored inside the distributed storage system 100 that is independent of the user terminal, and hence any influence from user malice or erroneous operation can be suppressed. Further, if a larger capacity for a file to be stored is desired, it is only necessary that a storage device be added, and thus there is no need to prepare a large number of user terminals. Further, there is no need to wait for the convergence of propagation of such information as management information among the storage devices. Further, the interface processors 21 to 25 can know which storage device stores a corresponding subfile through the file presence check request (Step S302b of FIG. 8), and hence there is no need to manage correspondence relationship between files (and subfiles) and storage devices.

Further, the user terminal 10 and the Internet 51 are located outside the distributed storage system 100, and thus are not affected by an increase in network load caused by the transmission/reception of information performed inside the distributed storage system 100. Further, the user terminal 10 is constructed by hardware different from those of the storage devices 31 to 39, and hence the transmission/reception of files or subfiles does not consume hardware resources of the user terminal 10.

Further, the interface processors 21 to 25 perform the exclusive control process by using tokens, and hence, integrity of the file to be written is maintained even if two or more users make a request for the write process simultaneously with respect to the same file.

According to the first embodiment described above, the DNS server 42 is connected to the LAN 52, and the storage devices 31 to 39 make an inquiry to the DNS server 42 to acquire the IP addresses of the interface processors 21 to 29. As an alternative, instead of providing the DNS server 42, each of the storage devices 31 to 39 may store the IP addresses of all of the interface processors 21 to 25. Further, each of the storage devices 31 to 39 may store the range of the IP addresses of the interface processors 21 to 25, such as information representing “192.168.10.21 to 192.168.10.25”. In this case, each of the storage devices 31 to 39 may cyclically select among the interface processors 21 to 25 when it makes a request to the interface processors in Step S105a of FIG. 5. Even with such a construction, the IP address of all of the storage devices 31 to 39 are contained in the node lists of a plurality of interface processors, and hence, similarly to the first embodiment, it is possible to improve the reliability and the continuous operability.

1. A distributed storage system, comprising:
a plurality of storage devices that store data; and
a plurality of interface processors that control the storage devices, wherein:
the interface processors and the storage devices are capable of communicating with each other via a communication network according to an IP protocol;
each of the interface processors stores a node list containing an IP address in the network of at least one of the storage devices;
each of the storage devices makes a request for the node list to different interface processors;
the interface processor to which the request has been made transmits the node list to the storage devices which has made the request; and
the interface processor to which the request has been made adds to the node list, the IP address of the storage device which has made the request.

2. A distributed storage system according to claim 1, further comprising a DNS server connected to the communication network, wherein:
the DNS server stores a predetermined host name and the IP addresses of the plurality of interface processors in association with the predetermined host name;
the DNS server makes, in response to an inquiry about the predetermined host name, a cyclic notification of one of the IP addresses of the plurality of interface processors;
the storage devices make the inquiry about the predetermined host name to the DNS server; and
the storage devices make the request for the node list based on the notified IP addresses of the interface processor.

3. A distributed storage system according to claim 1, wherein:
each of the interface processors stores at least one of the IP addresses of the storage devices contained in the node list, in association with information indicating a time point; and
each of the interface processors deletes from the node list, in accordance with a predetermined condition, the IP address of a storage device associated with information indicating an oldest time point.

4. A distributed storage system according to claim 1, wherein:
each of the storage devices stores the node list containing an IP address of at least one of other storage devices; and
each of the interface processors and each of the storage devices transmit, to at least one of the storage devices contained in the node lists thereof, information regarding control of the at least one of the storage devices.

5. A distributed storage system according to claim 4, wherein, with regard to one of the storage devices and another one of the storage devices included in the node list of the one of the storage devices:
the one of the storage devices deletes, from the node list thereof, the another one of the storage devices;
the another one of the storage devices adds, to the node list thereof, the one of the storage devices; and
the one of the storage devices and the another one of the storage devices exchange all storage devices contained in the node lists thereof, excluding the one of the storage devices and the another one of the storage devices.

6. A distributed storage system according to claim 1, wherein each of the storage devices updates their own node lists based on the node list transmitted from the interface processors.

7. A distributed storage system according to claim 1, wherein:
if each of the interface processors receives a request to write data from the outside, each of the interface processors performs transmission/reception of information regarding a write permission of the data to/from another one of the interface processors; and
each of the interface processors, which have received the request to write, gives an instruction to store the data, or gives no instruction, to the storage devices, in accordance with a result of the transmission/reception of the information regarding the write permission.
